(19) United States
(12) Patent Application Publication
(10) Pub. No.: US 2011/0037702 A1
(43) Pub. Date: Feb. 17, 2011

(54) PORTABLE ELECTRONIC DEVICE

(75) Inventor: TZU-CHENG YU, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/637,896

(22) Filed: Dec. 15, 2009

(30) Foreign Application Priority Data
Aug. 13, 2009 (CN) 200910305588.0

(51) Int. Cl. G06F 3/02

(52) U.S. Cl. 345/169

(57) ABSTRACT

A portable electronic device includes a main body and a peripheral component. The main body includes a first display, a first keypad, a MPU, a first display module, a first inputting module, and a storage module. The first display and the first keypad are disposed on a surface thereof. The first display module supports first display to display information received from the MPU. The first inputting module supports the first display or the first keypad to input information to the MPU. The storage module stores commands, programs, and data of the MPU. The peripheral component includes a second display and a second keypad disposed a surface thereon. When the main body is assembled with the peripheral component, the main body and the peripheral component can transmit signals to each other, and the MPU of the main body controls the second display and the second keypad.

### BACKGROUND

1. Technical Field

The disclosure generally relates to portable electronic devices, particularly to a first portable electronic device that can be attached to and detached from another portable electronic device, which can be used to input and view data from the first portable electronic device.

2. Description of Related Art

With developments in wireless communication and information processing technologies, portable electrical devices such as mobile phones and personal digital assistants (PDAs) are now in widespread use, and consumers may now enjoy the full convenience of high tech products almost anytime and anywhere. Keypads and displays are necessary components of these portable electrical devices. However, the keypads and the displays usually have very small sizes and are not convenient for users to operate.

Therefore, there is room for improvement within the art.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the portable electronic device.

FIG. 1 shows a block diagram of a portable electronic device, according to a first exemplary embodiment.

FIG. 2 shows schematic view of the portable electronic device shown in FIG. 1 with the peripheral component detached from the main body.

FIG. 3 shows an assembled, schematic view of the portable electronic device shown in FIG. 1.

FIG. 4 shows a block diagram of a portable electronic device, according to another exemplary embodiment.

### DETAILED DESCRIPTION

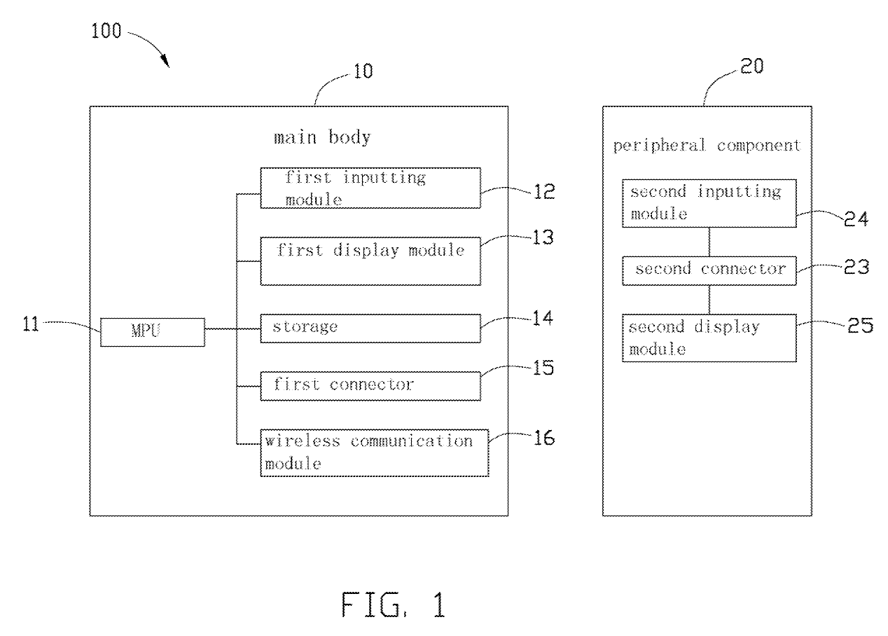

Referring to FIG. 1, a portable electronic device 100 according to a first exemplary embodiment and includes a main body 10, and a peripheral component 20. The main body 10 is capable of independently receiving input and displaying information. Also the main body 10 can be assembled and electrically connected to the peripheral component 20, and the peripheral component 20 used to input to and display data of the main body 10.

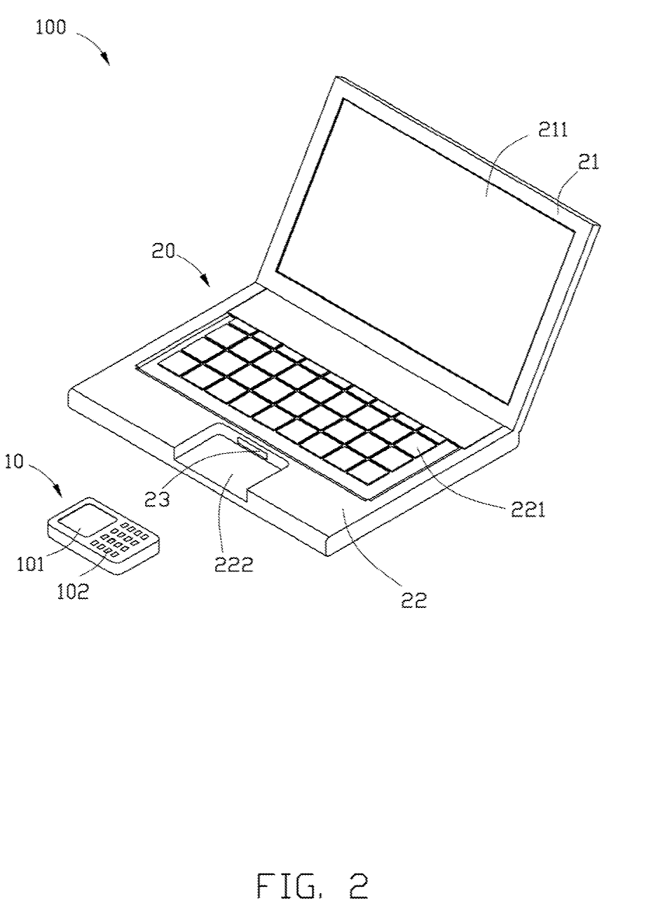

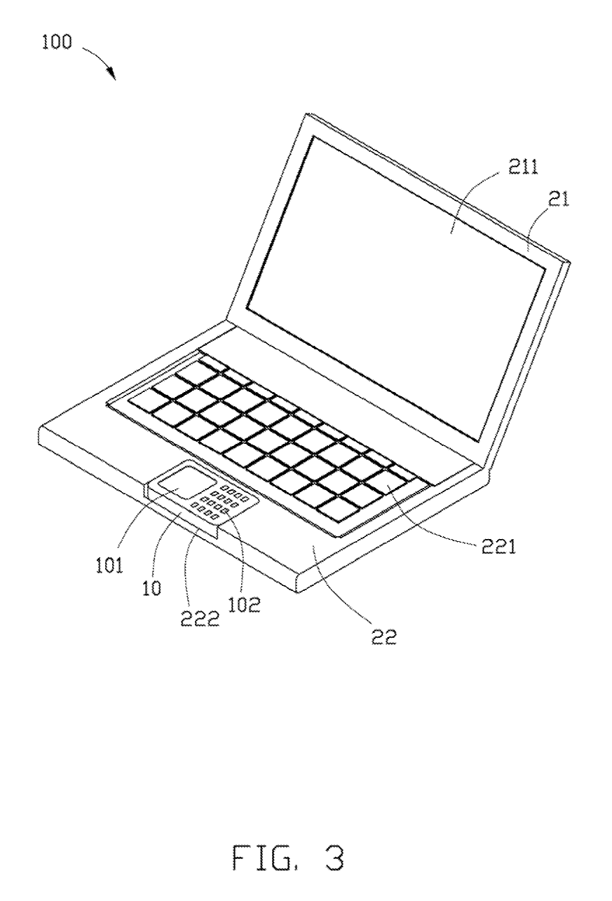

Referring to FIGS. 2-3, the main body 10 may be a conventional portable electronic device such as a mobile phone or a PDA. A first display 101 and a first keypad 102 are disposed on one surface of the main body 10. The main body 10 includes a microprocessor unit (MPU) 11, a first inputting module 12, a first display module 13, a storage module 14, a first connector 15, and a wireless communication module 16 mounted therein.

The MPU 11 may be a central processing unit (CPU) of a conventional portable electrical device. The MPU 11 is electrically connected to and controls the first inputting module 12, the first display module 13, the storage module 14, the connector 15, and the wireless communication module 16. The first inputting module 12 may be an integrated circuit (IC) supporting input from the first display 101 or the first keypad 102 to the MPU 11. The first display module 13 may be an IC supporting the first display 101 to display information received from the MPU 11. The storage module 14 stores commands, programs, and data of the MPU 11. The first connector 15 is used to transmit signals between the main body 10 and the peripheral component 20. The wireless communication module 16 is used to communicate with other communication devices.

The peripheral component 20 includes a cover 21, a base body 22, a second connector 23, a second inputting module 24, and a second display module 25. The cover 21 is rotatably assembled to the base body 22 by a hinge (not shown). The cover 21 and the base body 22 may be housings of a conventional laptop. A second display 211 is disposed in one side of the cover 21 facing the base body 22. A second keypad 221 is disposed in the base body 22. The sizes of the second display 211 and the second keypad 221 are larger than the first display 101 and the first keypad 102 and when connected to the main body 10 are convenient for inputting to the main body 10 and viewing data stored in the main body 10. A mounting area 222 is defined in the base body 22 along one edge thereof, corresponding to the main body 10.

The second connector 23 is mounted in the mounting area 222 of the base body 22. The second inputting module 24 and the second display module 25 are substantially similar to the first inputting module 12 and the first display module 13, and corresponding to the second keypad 221 and the second display 211. The second inputting module 24 and the second display module 25 are mounted in the base body 22, and electrically connected to the connector 23. When the main body 10 is received in the mounting area 222, the second connector 23 is electrically connected to the first connector 15, and the MPU 11 controls the second keypad 221 of the second inputting module 24 and the second display 211 of the second display module 25.

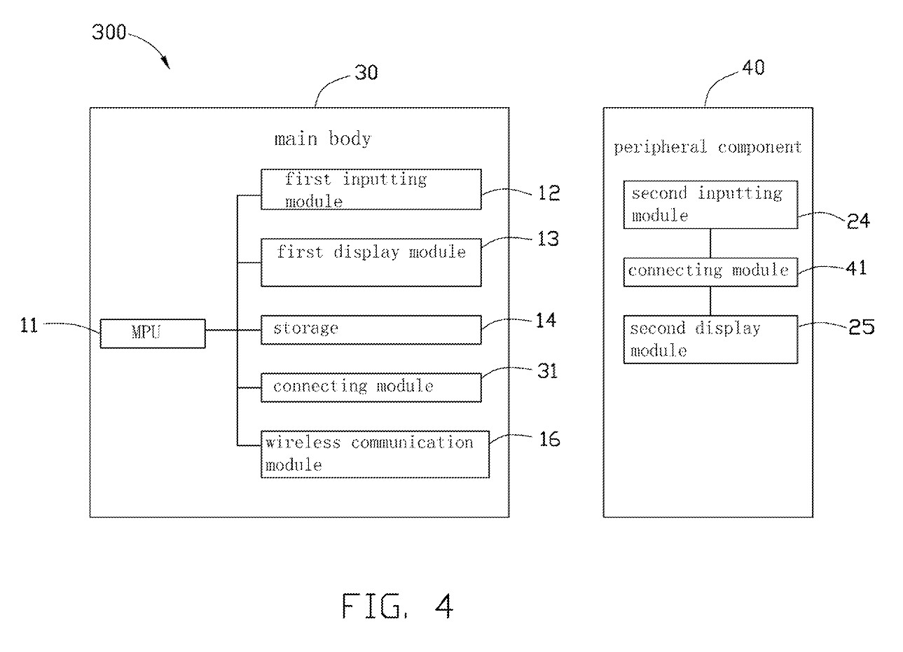

Referring to FIG. 4, a portable electronic device 300 according to another exemplary embodiment is similar to the portable electronic device 100 and includes two connecting modules 31, 41 replacing the first connector 15 and the second connector 23. The connecting modules 31, 41 may be BLUETOOTH communication modules, infrared communication modules or a ultra wide band (UWB) modules set in the main body 30 and the peripheral component 40 to enable wireless communication between the main body 30 and the peripheral component 40. Also, the mounting area 222 may be omitted and the second connector 23 formed instead on a sidewall of the base body 22 in other embodiment.

The main body 10, 30 of the portable electrical device 100, 300 can be detached from the peripheral component 20, 40 to work independently, and be conveniently portable. Furthermore, the main body 10, 30 can be assembled to the peripheral component 20, 40 when users desire to use a larger display 211 and/or larger keypad 221.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a main body, comprising:
a first display and a first keypad disposed on a surface of the main body;
a MPU mounted in the main body;
a first display module supporting the first display to display information received from the MPU;
a first inputting module supporting input from the first display or the first keypad to the MPU;
a storage module storing commands, programs, and data of the MPU; and
a first connecting module; wherein when the main body is electrically connected to a peripheral component using the first connecting module, the MPU of the main body controls a second display and a second keypad of the peripheral component.

2. The portable electronic device as claimed in claim 1, wherein the peripheral component includes a base body and a cover rotatably assembled to the base body, the second display is disposed in the cover, and the second keypad is disposed in the base body.

3. The portable electronic device as claimed in claim 2, wherein the peripheral component further includes a second connecting module, the first connecting module and the second connecting module enable wireless communication between the main body and the peripheral component.

4. The portable electronic device as claimed in claim 3, wherein the peripheral component further includes a second display module and a second inputting module, corresponding to the second keypad and the second display, and connected to the second connecting module.

5. The portable electronic device as claimed in claim 2, wherein a mounting area is defined on the base body to assemble the main body therein.

6. The portable electronic device as claimed in claim 1, wherein the size of the second display and the second keypad is lager than that of the first display and the first keypad.

7. The portable electronic device as claimed in claim 3, wherein the connecting module is a Bluetooth communication module.

8. The portable electronic device as claimed in claim 3, wherein the connecting module is an infrared communication module.

9. The portable electronic device as claimed in claim 3, wherein the connecting module is a ultra wide band module.

10. A portable electronic device, comprising:
a main body, comprising:
a first display and a first keypad disposed on a surface of the main body;
a MPU mounted in the main body;
a first display module supporting the first display to display information received from the MPU;
a first inputting module supporting input from the first display or the first keypad to the MPU; and
a storage module storing commands, programs, and data of the MPU; and
a peripheral component including a second display and a second keypad disposed on a surface thereof; wherein when the main body is electrically connected to the peripheral component, the MPU of the main body controls the second display and the second keypad.
